(19) United States
(12) Patent Application Publication
(10) Pub. No.: US 2012/0017501 A1
(43) Pub. Date: Jan. 26, 2012

(54) Modular plant support

(76) Inventor: Marlene Katherine Koopmeiners, Avon, MN (US)

(21) Appl. No.: 12/804,497

(22) Filed: Jul. 23, 2010

(51) Int. Cl. A01G 17/04

(52) U.S. Cl. 47/45

(57) ABSTRACT

A modular plant support system is described which provides a structure within which a plant may be grown and physically supported. The plant support structure has three or more vertical members and a number of cross members connected to each other by metal or plastic pipe fittings, which provide the modular feature of the structure. The vertical members are pipe-like and connect to each horizontal member at the fittings. The vertical members are hollow and fit over rod-type staking structures. The layers of the horizontal members may be stacked at any reasonable height to support the requirements of the plant. It is easily assembled and dissembled without tools and can be compactly stored in the dissembled state.

### CROSS REFERENCE TO RELATED APPLICATIONS

Not Applicable

### FEDERALLY SPONSORED RESEARCH

Not Applicable

### SEQUENCE LISTING OF PROGRAM

Not Applicable

### BACKGROUND OF THE INVENTION

It is known by gardeners that growing plants often require support during growth. Many examples are well known. For example, vegetable producing plants, such as tomatoes, require support while growing. Flowers, such as peonies, also require support while they are flowering. The flowers, or the fruit become too heavy for the plant stalk. If left unsupported, it can cause the whole plant to collapse on itself, or fall to one side.

Traditionally, gardeners use a wire cage-type support. As the gardener presses the support wires into the ground, they tend to bend and stay bent upon removal at the end of the growing season. This causes them to be good for only a single season. These cages can be cumbersome to store as they become easily bent so stacking them becomes nearly impossible. These cages are welded together and therefore are not able to be adjusted for different plant height requirements. These cages cannot be dissembled for storage. They are also difficult to clean up at the end of the season.

Another variety of plant support is to use one or more stakes driven into the soil and some sort of flexible material to tie the plant to the stake to support it. This process is time-consuming and can also damage the plant as wind and growth cause the plant to rub against the material. This support is also visually unattractive and only supports the parts of the plant that have been tied to the stake.

### OBJECTS AND ADVANTAGES

Accordingly, several advantages of the present invention are:
1) To provide a plant support that is durable, will not wear out, bend or break easily
2) To provide a plant support that is easy to clean up at the end of the season to help prevent the spread of diseases to future plants
3) To provide a plant support that is easy to assemble and dissemble
4) To provide a plant support that has adjustable height to support individual plant requirements
5) To provide a plant support that can be produced in a variety of sizes and shapes to fit a variety of plants
6) To provide a plant support that is attractive

### SUMMARY

The present invention is directed to an apparatus that satisfies the need for an effective modular plant support structure. The support structure is comprised of three or more vertical members and a number of cross members connected to each other by pipe fittings. The vertical members are hollow and fit over rod-type staking structures that can be pressably embedded into the ground, providing support for the structure.

### DRAWINGS-FIGURES

FIG. 1 is a side view of the invention fully assembled

FIG. 2 is a side view of the invention in the dissembled state showing the rod-type staking structures (50) extending vertically through the pies

FIG. 3 is a top view of the invention

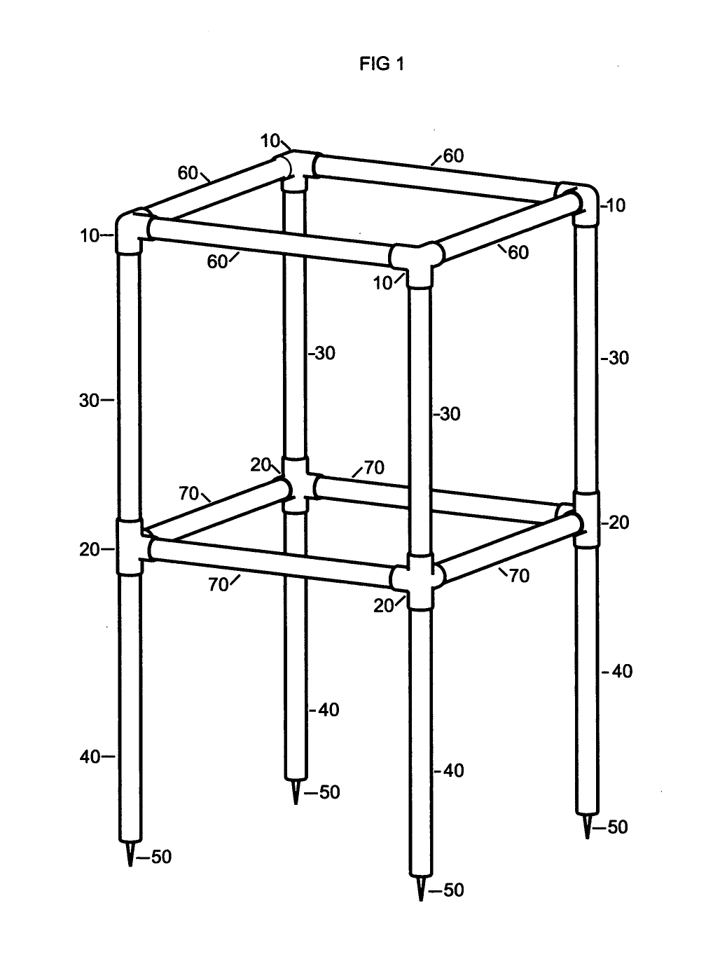

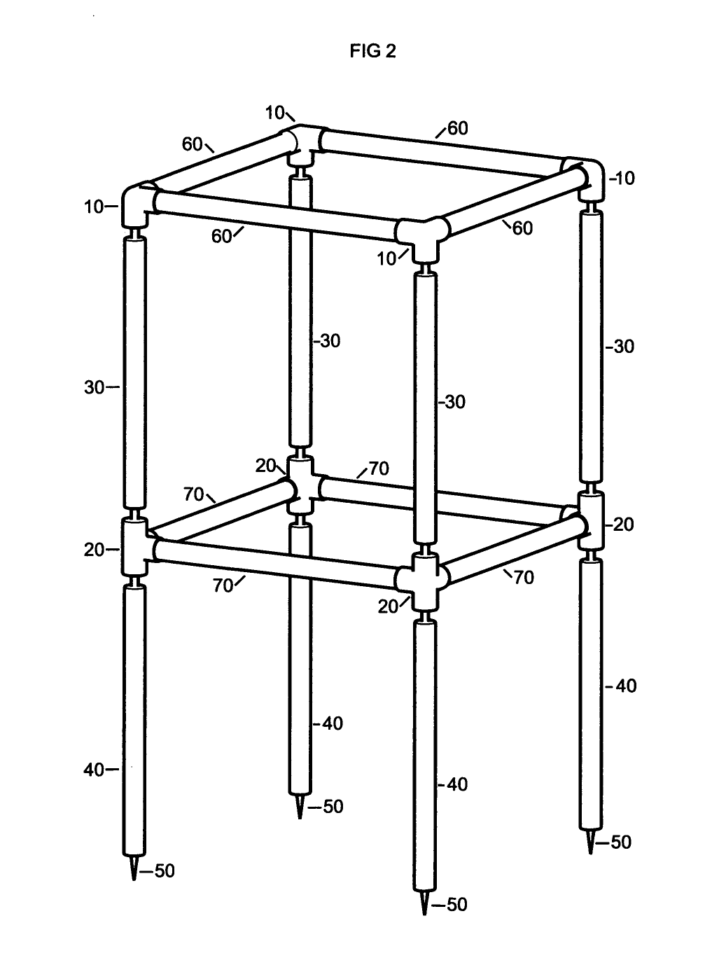

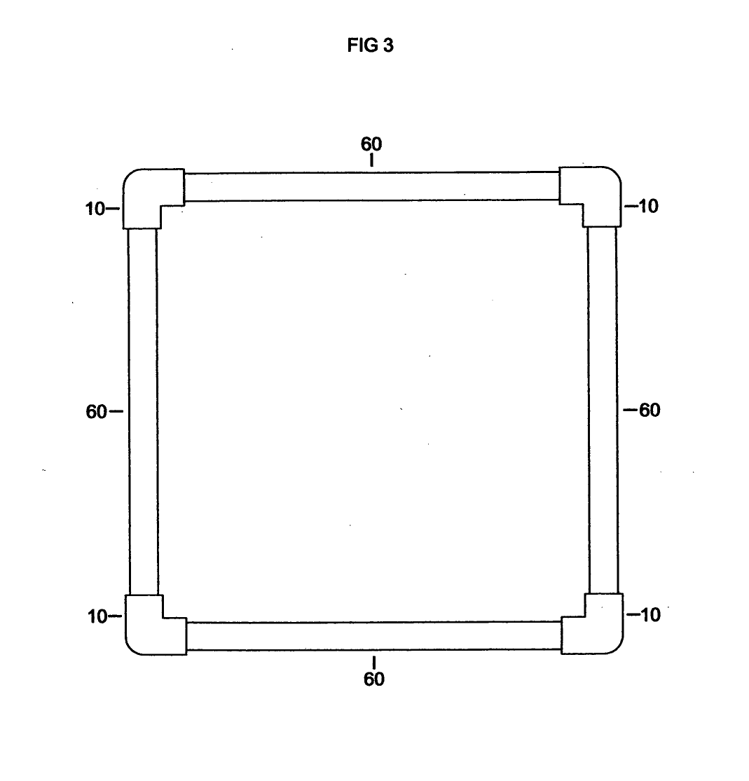

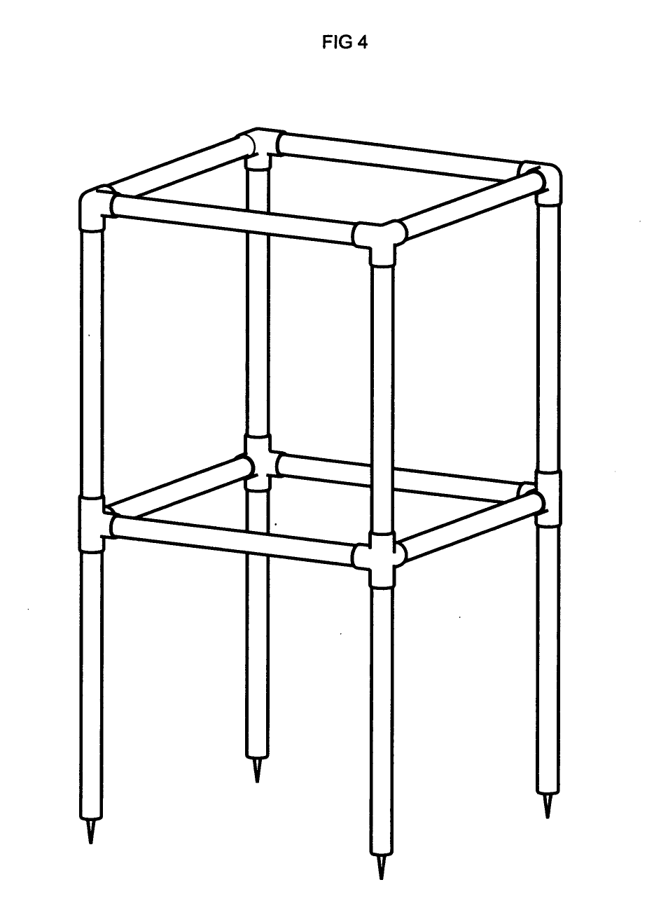

### DETAILED DESCRIPTION

In preparation for explaining the details of the present inventive disclosure, it is understood by the reader that the invention is not limited to the present details of the construction, materials and embodiments as illustrated in the accompanying drawings as the invention concepts are clearly capable of other embodiments an of being practiced and realized in various ways by applying the disclosure presented herein.

The invention is a plant support that can be easily put together by constructing modular sections from pipe (60) (70) and pipe fittings (10) (20), and attaching said pipes and pipe fittings to form a rigid shape. Any reasonable number of sections can be stacked by inserting spacers (30) between said pipe fittings (20) (10). Rod-type staking structures (50) are pressably embedded into the ground in the predetermined shape and size of the support and inserted into the vertical members (20) (30) (40) of the support.

What is claimed is:

1. A plant support system consisting of (a) pipe (b) pipe fittings (c) a plurality of ground stakes made of suitable material and thickness first being able to be pressably embedded into the soil and an opposing second end being vertically inserted into the pipe that comprises the vertical members of the structure.

2. The plant support in claim 1, wherein the pipe and pipe fittings are affixed to form a horizontal polygon.

3. The plant support in claim 1, wherein pipes are placed vertically between pipe fittings to serve as spacers between the horizontal polygons

4. The plant support in claim 1, wherein vertical pipes surround the vertical stakes to provide the support to the structure.

5. The plant support in claim 1, wherein polygons and the spacers can be layered at any reasonable height to support the requirements of the plant.
